(19) United States
(12) Patent Application Publication
(10) Pub. No.: US 2017/0065913 A1
(43) Pub. Date: Mar. 9, 2017

(54) UPWARD FLOWING IN-LINE STRAINER

(71) Applicant: Eaton Corporation, Cleveland, OH (US)

(72) Inventor: Vincent Anthony AMAROSA, Howell, NJ (US)

(73) Assignee: Eaton Corporation, Cleveland, OH (US)

(21) Appl. No.: 15/122,679

(22) PCT Filed: Apr. 2, 2015
(86) PCT No.: PCT/US15/23966

§ 371 Date: Aug. 31, 2016

Related U.S. Application Data
(60) Provisional application No. 61/975,048, filed on Apr. 4, 2014.

(51) Int. Cl. B01D 29/90; B01D 29/13; B01D 29/44

(52) U.S. Cl. CPC B01D 29/904; B01D 29/445; B01D 29/13

(57) ABSTRACT

A strainer assembly for a pressurized fluid system having a pressure vessel with an oppositely directed inlet and outlet located thereon at a common elevation and a drain port in the bottom. A tubular diverter is disposed in the pressure vessel with an annular member sealed about the lower end of the diverter at an angle to the diverter axis and having its outer periphery sealed about the pressure vessel with one side of the member above the inlet and the opposite side below the outlet and isolating the inlet from the outlet. A cover is releasably disposed in fluid sealing engagement over the upper end of the diverter and includes a cylindrical strainer retained in the cover by a support ring having outwardly extending portions connected to the cover; and, the support ring is sealed over the upper end of the diverter. Fluid from the inlet flows upwardly through the diverter through the support ring and into the strainer. Flow emanating from the strainer flows downwardly around the diverter to the outlet. Large debris settles downwardly through the diverter to the bottom of the pressure vessel and is removed by selectively opening the drain port.

This application claims priority to U.S. Provisional Patent Application No. 61/975,048, filed Apr. 4, 2014, by Vincent Anthony Amarosa, entitled “UPWARD FLOWING COURSE IN-LINE STRAINER” and is incorporated herein by reference in its entirety.

### BACKGROUND

The present disclosure relates to strainers or filters for removing foreign material or debris in pressurized fluid flow systems. Heretofore, such systems have employed a strainer or filter basket in a fluid pressure vessel having an inlet disposed above the outlet and debris trapped by the strainer or filter remains in the basket. In order to remove the collected debris, it has heretofore been necessary to stop the fluid process and shut off flow to the inlet and outlet and depressurize the vessel in order to remove the pressure vessel cover or lid and remove the basket for cleaning or replacement. This has resulted in unwanted downtime for the fluid flow process. Therefore, it has been desired to provide a way or means of removing the debris, and in particular, relatively large particles trapped by the filter or strainer and to do so without depressurizing and opening the pressure vessel.

### SUMMARY

The present disclosure relates in particular to problems encountered in mining industries where it is desired to remove debris, such as rocks, from a liquid slurry on a continuing process basis in which it is desired to trap and remove the debris without significantly interrupting the process. Strainers employed for this type of process encounter substantial quantities of debris which requires frequent emptying of the trapped debris strainer.

The present disclosure provides for relatively coarse straining of debris from pressurized fluid flow systems and utilizes a pressure vessel with an inlet, an outlet disposed at a common lower level than the strainer. The disclosed assembly operates by directing flow from the inlet upwardly through a tubular diverter to the interior of a generally cylindrical strainer. Flow exiting the strainer flows about the exterior of the strainer and downwardly around the tubular diverter and into a chamber in the pressure vessel isolated from the inlet and outwardly through the pressure vessel outlet. The lower end of the tubular diverter in the pressure vessel is formed at an angle and surrounded by a ring sealed against the inner periphery of the pressure vessel; and, the pressure vessel inlet is adjacent the elevated side of the angled diverter and the pressure vessel outlet is adjacent the lower level side of the angled end of the diverter. This arrangement enables the inlet and outlet to be positioned at a common elevation rendering the assembly convenient for in-line installation in the fluid process system. Debris trapped in the strainer settles by gravity flow downwardly through the interior of the tubular diverter through the angled open lower end thereof and into the bottom of the pressure vessel. Removal of the heavy debris is accomplished by opening a drain port provided in the lowest level of the pressure vessel wall. The drain port may be connected to a conduit and a remotely operated drain valve. The cylindrical strainer may be formed, in one version, as having a pleated perforated metal wall; and, in another version, the strainer is formed of a plurality of annular bands having a triangular transverse section and spaced a desired distance through the strainer for controlling the size of the debris permitted to pass.

In the disclosed versions, the strainer is sized and configured for trapping and removing coarse debris such as for applications in mining industry. However, the arrangement of the strainer or filter above the inlet and outlet and for directing upward flow for straining and permitting debris trapped in the strainer to settle by gravity downwardly into the pressure vessel for subsequent removal without depressurization and removal of the strainer or filter may also be employed for operations requiring finer filtering than employed for straining.

Removal of the debris or filtered particles, as the case may be, may be accomplished either by closing the inlet and permitting the removal of debris by backflow from the outlet; or, debris removal may be accomplished by closing the outlet and opening the drain port to permit pressure flushing of the debris from inlet pressure.

### BRIEF DESCRIPTION OF THE DRAWINGS

FIG. 1 is a top view of the exterior of the pressure vessel of the strainer assembly of the present disclosure;

FIG. 2 is an exploded section view taken along section indicating lines 2-2 of FIG. 1 and shows the interior construction of the assembly of FIG. 1;

FIG. 3 is an enlarged view of the strainer illustrated in FIG. 2;

FIG. 4 is a section view taken along section indicating lines 4-4 of FIG. 3;

FIG. 5 is a view similar to FIG. 3 of a second version of the strainer of the assembly of FIG. 1;

FIG. 6 is a section view taken along section indicating lines 6-6 of FIG. 5;

FIG. 7 is an enlarged view of the lower portion of the strainer of FIG. 5;

FIG. 8 is a portion of a view similar to FIG. 1 showing another version of the tubular diverter; and,

FIG. 9 is a plan view of the strainer support ring of FIG. 2.

### DETAILED DESCRIPTION

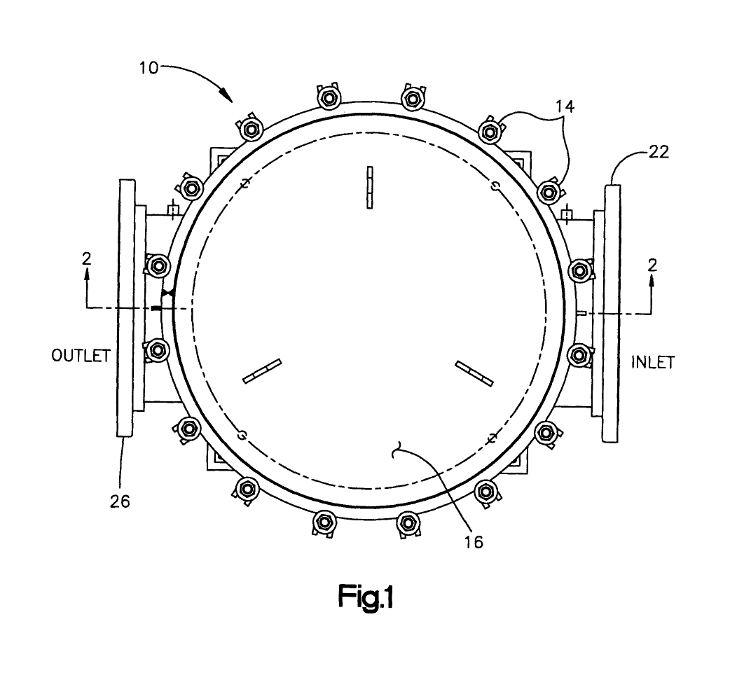

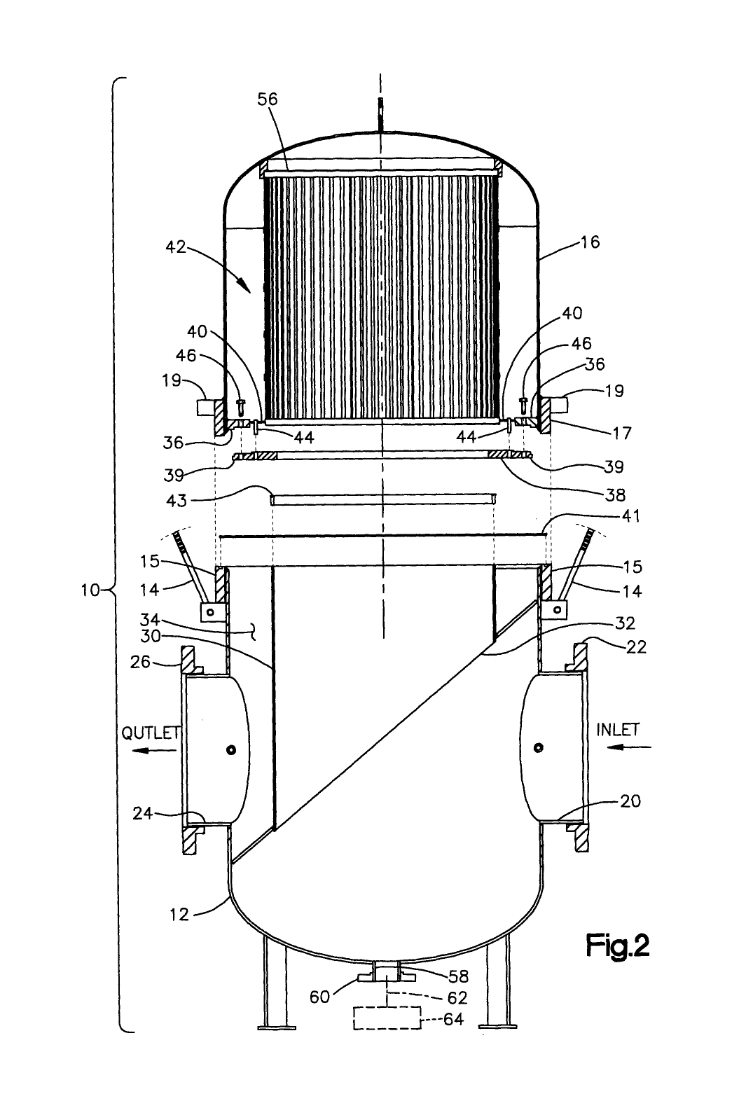

Referring to FIGS. 1 and 2, a strainer assembly in accordance with the present disclosure is indicated generally at 10 and employs a pressure vessel 12 having the wall thereof formed in a generally cylindrical cupped shaped configuration with the upper end thereof open and having an attachment ring 15 secured thereabout such as by weldment. A generally cylindrical inverted cup shaped cover 16 is received thereover and releasably attached thereto by suitable fasteners such as swing bolts 14. The cover has a clamping band 17 attached thereto such as by weldment, with slotted tabs or lugs 19 for contact by the swing bolts 14. Alternatively, clamps or a clamping band may be used in place of swing bolts. The assembly is supported by legs 18 attached to the bottom of the pressure vessel 12. The pressure vessel has an inlet 20 which has a fitting in the form of annular flange 22 which is adapted for connection to a conduit of the fluid pressure system for which the assembly 10 is being placed in service. A fluid outlet 24 is provided on the wall of the pressure vessel diametrically opposite the inlet 20 and located at the same or a common elevation as the inlet 20. The outlet 24 similarly is provided with an annular flange 26 for connection to a flow conduit in the system serviced by the assembly 10.

The pressure vessel has a tubular diverter 30 securely attached at its lower end, in fluid sealing arrangement, to the inner periphery of a ring 28, as for example, by weldment. The flow diverter 30 has the lower end thereof formed at an angle with respect to the central axis of the pressure vessel; and, in the present practice, it has been satisfactory to form the angle of the lower end of the diverter 30 at an inclination of about 50 degrees to the central axis of the pressure vessel. However, the angular inclination of the lower end of the diverter 30 may be formed at other angles of inclination if found expedient. The inclined lower end of the tubular diverter is denoted by reference numeral 32 in FIG. 2 and is open to permit upward flow of fluid from inlet 20. The lower end 32 of the diverter 30 has disposed thereabout and sealed therearound, such as by weldment, of the elliptical ring 28 which has its outer periphery sealed against the inner surface of the pressure vessel wall by suitable expedient as, for example, weldment. The ring 28 and the wall of the diverter 30 together isolate the inlet 20 from the outlet 24. The annular space 34 about the diverter 30 is, thus, open to the upper end of the pressure vessel but is isolated from the inlet 20.

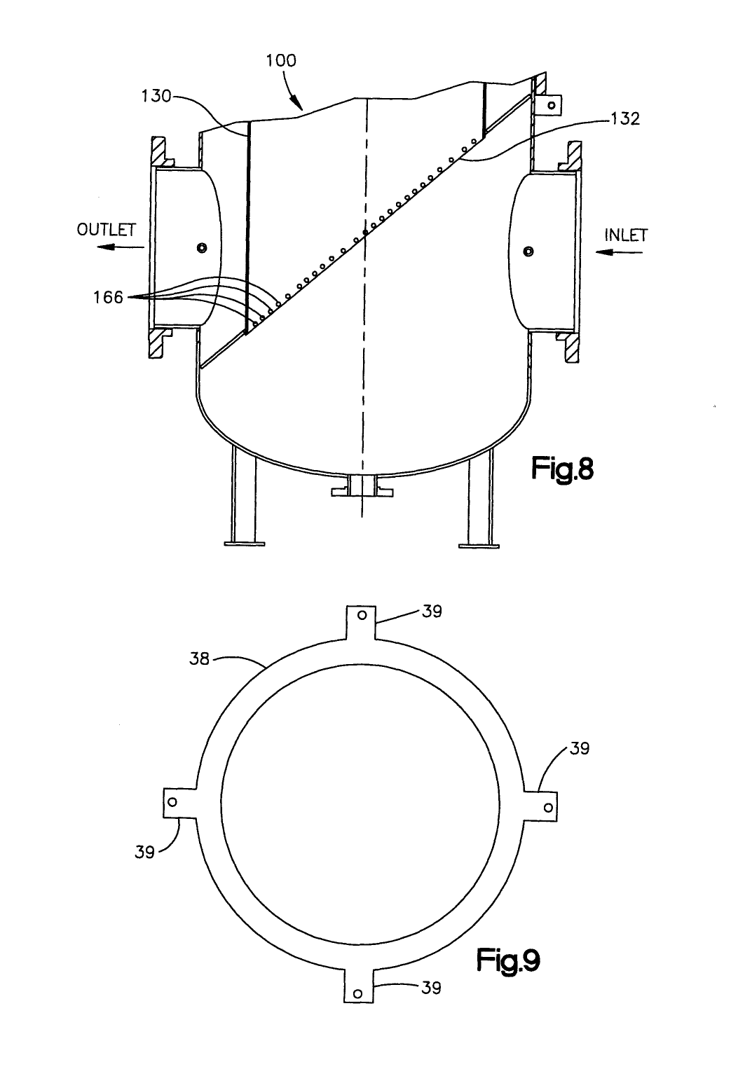

The cover 16 has a plurality of mounting tabs 36 attached inside the lower open end thereof, which tabs 36 have has attached thereto a mounting or strainer support ring 38 which has secured thereto mounting tabs 40 of a strainer indicated generally at 42 by suitable expedient such as pins 44. The support ring 38 has a plurality of radially outwardly extending lugs 39 (see FIG. 9) each of which is secured to one of the tabs 36 by a bolt or screw 46.

At assembly with cover 16 secured by swing bolts 14, strainer tabs 40 are pinned to support ring 38 and tabs 39 bolted to tabs 36. The cover clamping band 17 is sealed on pressure vessel attachment ring 15 by a suitable seal such as an O-ring 41. The support ring is sealed over the upper edge of the tubular diverter 30 by an annular seal ring 43, which, in the present practice, has an inverted U-shape in cross section; however, other configurations of seal ring 43 may be used.

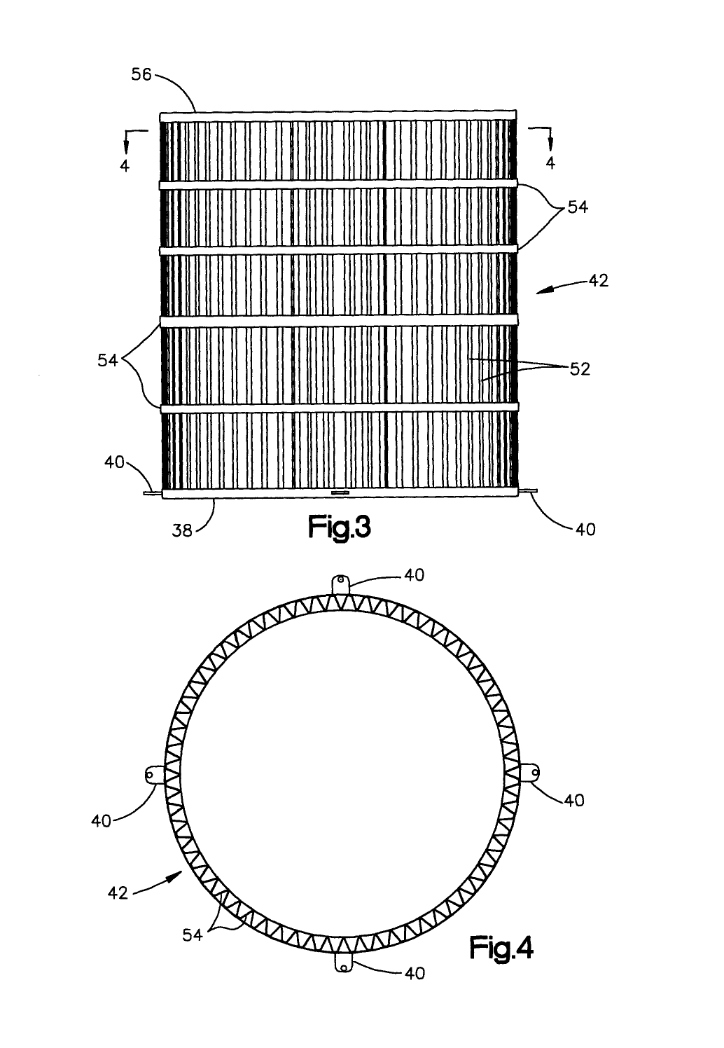

Referring to FIGS. 3 and 4, the strainer 42 is shown in detail and has the strainer wall 52 thereof formed in a corrugated or pleated manner as shown in greater detail in FIG. 4. The pleated or corrugated material 52 may be formed of suitable sheet metal; and, in the present practice, it has been found satisfactory to form the corrugations having a radial depth of about 1.25 inches (32 mm) for a strainer having an inner diameter of about 25 inches (63.5 cm). In the present practice, it has been found satisfactory to form the strainer of type 316 stainless steel; however, other suitable corrosion resistant metals may also be employed. In the present practice, the strainer material 52 is perforated with a plurality of holes of diameter in the range of about 0.01 inches (0.25 mm) to about 0.5 inches (12.7 mm) for various applications. The strainer 42 has a plurality of retaining bands 54 provided thereabout for maintaining the cylindrical shape of the strainer; and, the bands are disposed in axially spaced arrangement as shown in FIG. 3. The strainer material 52 has a cap or cover plate 56 provided upper end thereof as shown in FIG. 3 and secured thereto to prevent escape of upwardly flowing unstrained fluid.

In operation, fluid from inlet 20 flows upwardly through the interior of diverter 32 and flows upwardly through the support ring 38, into the interior of strainer 42. Flow of strained fluid exiting the strainer 42 flows downwardly around support ring 38 and into the annular space 34 around diverter 30 and outwardly through outlet 24. Debris trapped in strainer 42 settles by gravity flow through diverter 30 to the bottom of pressure vessel 12.

A drain port 58 is provided in the bottom of the pressure vessel wall 30 and includes a mounting flange 60 which is adapted for connection to a conduit 62 shown n dashed line in FIG. 2 which may be connected to a remotely actuated valve 64 also shown in dashed line in FIG. 2.

When it is desired to drain the debris, which has settled in the bottom of the pressure vessel 30, this may be accomplished in either of two ways. The first way of draining the debris from pressure vessel 30 is accomplished by shutting off flow to the inlet 20 by a valve (not shown) and opening the drain port 58 which permits back pressure in the outlet 24 to flush the debris through drain port 58. The second way is accomplished by leaving the inlet port 20 open and closing the outlet port 24 by a valve (not shown) and permitting inlet flow pressure to flush debris to the drain port. It will be understood that the first way utilizes strained fluid at discharge line pressure; whereas, the second way utilizes unstrained fluid at inlet line pressure for flushing the debris.

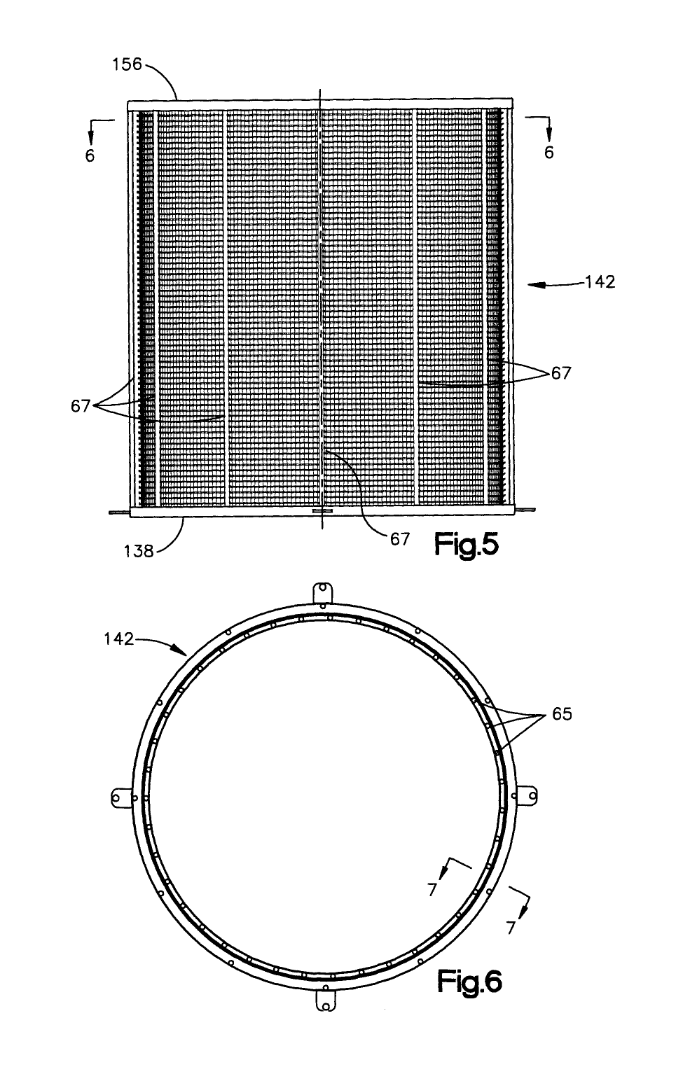

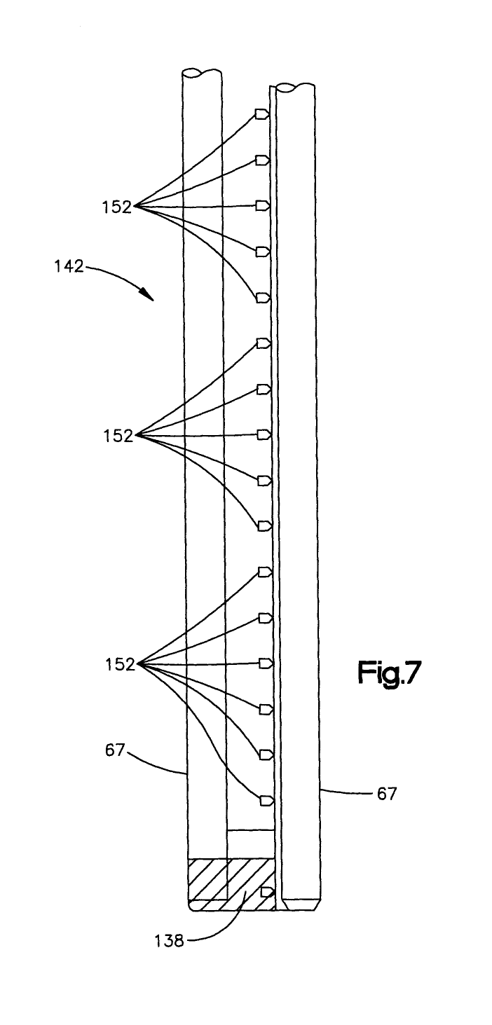

Referring to FIGS. 5-7, another version or embodiment of the strainer is shown at 142 in which the straining material comprises a plurality of vertically spaced annular bands or wires 152, in the present practice, having a triangular transverse section, as shown in FIG. 7, oriented with the base of the triangle facing the interior of the cylindrical arrangement of the bands. The bands are supported by vertical members 65 as shown in FIG. 6. A cap 156 and baseplate 138 are retained over the array of wires by a plurality of circumferentially spaced axially extending rods 67 as shown in FIG. 7 in detail.

In the present practice, it has been found satisfactory to form the pressure vessel of carbon steel; however, the pressure vessel may be formed of other materials as, for example, stainless steel or a composite material.

Referring to FIG. 8, another version of the strainer assembly of the present disclosure is indicated generally at 100 and has the arrangement and configuration similar to that of the version of FIG. 1; however, in the version 100, the tubular diverter 130 has the lowered angled end 132 thereof provided with a plurality of spaced bars 166 disposed thereacross to prevent upward flow of heavy debris that could cause damage to the strainer. The embodiment 100 is otherwise similar to the version 10 of FIGS. 1 and 2. In the present practice, for a strainer of 25 inches diameter it has been found satisfactory to employ rods 166 having a diameter of about 0.5 inches (12.7 mm).

The present disclosure thus provides a strainer for pressurized fluid flow for removing debris therefrom and employs a pressure vessel having an inlet and outlet at the common elevation with a strainer disposed vertically above the inlet and the outlet. The assembly of the present disclosure employs a tubular diverter having the lower end thereof extending into the pressure vessel and the interior of the tubular inverter is isolated from the outlet by an elliptical ring surrounding the diverter. Flow from the inlet is directed upwardly into the interior of a cylindrical strainer. Strained fluid emanating from the strainer flows downwardly around a support ring into an annular region surrounding the diverter which communicates with the outlet. Debris trapped within the strainer settles by gravity downwardly to the interior of the diverter and into the lower region of the pressure vessel. When it is desired to remove the trapped debris, a drain port is opened in the bottom of the pressure vessel to permit the debris to flow out of the pressure vessel. The debris may be flushed either by closing the inlet and permitting backflow from the outlet, or alternatively, by closing the outlet and permitting pressurized fluid from the inlet to flush debris through the drain port. The strainer assembly of the present disclosure, thus, enables draining of the trapped debris in the strainer without the need for shutting down the process flow in the system, depressurizing the pressure vessel and removing the cover and strainer for cleaning or replacement. The strainer assembly of the present disclosure, thus, enables removal of trapped debris from the strainer without significant interruption of the fluid flow in the process in which the strainer is in service.

1. A strainer assembly for filtering fluid flow in a pressurized system comprising:
(a) a pressure vessel having an inlet and outlet and an open end disposed vertically above the inlet and outlet;
(b) a cup shaped cover disposed over the said open end wherein the cover includes disposed and retained therein a strainer element, the cover being releasably attached to the pressure vessel;
(c) a tubular diverter disposed in the pressure vessel and having an outwardly extending annular member provided about a first lower end thereof with the member contacting and sealed about the inner periphery of the pressure vessel, the member disposed at an angle with respect to the axis of the tubular diverter with one side of the member disposed above the inlet and a side opposite the one side thereof below the outlet thereby isolating the inlet from the outlet;
(d) an annular strainer support disposed and sealed about an end opposite the first lower end of the diverter, the annular strainer support having portions thereof connected to the cover for supporting the strainer therein, wherein fluid from the inlet flows upwardly through the tubular diverter into the upstream side of the strainer element and strained fluid flows outwardly from the downstream side thereof through a space between the pressure vessel and the annular strainer support and downwardly through a space between said tubular diverter and the pressure vessel to the outlet, wherein particulate debris settles by gravity downwardly from the strainer element through the tubular diverter into the pressure vessel; and,
(e) a drain port in the pressure vessel, the port being selectively openable for removing settled debris therefrom without the need for depressurizing and removing the cover and strainer element.

2. The assembly of claim 1, wherein the cover is attached to the pressure vessel with swing bolts.

3. The assembly of claim 1, wherein the pressure vessel has a cylindrical configuration with the inlet and outlet diametrically opposed thereon.

4. The assembly of claim 1, wherein the inlet and outlet are disposed at a common level.

5. The assembly of claim 1, wherein the strainer element has a generally cylindrical tubular configuration with the interior surface forming the upstream side thereof.

6. The assembly of claim 5, wherein the strainer element includes pleated material.

7. The assembly of claim 1, wherein the pressure vessel and cover are formed of one of corrosion resistant metal, stainless steel and carbon steel.

8. The assembly of claim 1, wherein the annular ring is angled 50 degrees with respect to the axis of the tubular diameter.

9. The assembly of claim 1, wherein the annular ring has an elliptical configuration.

10. The assembly of claim 1, wherein the cover is sealed about the open end of the pressure vessel with an annular seal.

11. The assembly of claim 1, wherein the drain port includes a valve.

12. The assembly of claim 1, wherein the drain port is located at the vertically lowest point of the pressure vessel.

13. The assembly of claim 1, wherein the strainer element has a generally cylindrical configuration, the upper end thereof attached to an inner surface of the cover.

14. The assembly of claim 1, wherein the flow apertures are disposed circumferentially in equally spaced arrangement.

15. The assembly of claim 1, wherein the cover has a generally inverted cup shaped configuration.

16. The assembly of claim 1, wherein the tubular diverter includes a plurality of spaced bars therein disposed about the first lower end.

17. The assembly of claim 1, wherein the filter element is operative to permit passage of particles smaller than about 165-170 microns.
